(19) United States
(12) Patent Application Publication
(10) Pub. No.: US 2026/0162007 A1
(43) Pub. Date: Jun. 11, 2026

(54) METHOD AND APPARATUS WITH DYNAMIC ENVIRONMENT STATE PREDICTION

(71) Applicant: Samsung Electronics Co., Ltd., Suwon-si (KR)

(72) Inventors: Sujin JANG, Suwon-si (KR); Dae Ung JO, Suwon-si (KR); Dohyun JANG, Suwon-si (KR); Jawook HUH, Suwon-si (KR)

(73) Assignee: Samsung Electronics Co., Ltd., Suwon-si (KR)

(21) Appl. No.: 19/230,579

(22) Filed: Jun. 6, 2025

(30) Foreign Application Priority Data
Dec. 11, 2024 (KR) 10-2024-0184011

(51) Int. Cl. G06N 20/00

(52) U.S. Cl. CPC G06N 20/00

(57) ABSTRACT

A processor-implemented method includes extracting a first state variable from first observation data, extracting action data that acts according to an action policy, selecting a first selected causal variable variably based on the first state variable and the action data, extracting a predicted second state variable by predicting a state change based on the first selected causal variable and the action data, and training a dynamic causal environment model based on the predicted second state variable and second observation data.

### CROSS-REFERENCE TO RELATED APPLICATIONS

This application claims the benefit under 35 USC § 119(a) of Korean Patent Application No. 10-2024-0184011, filed on Dec. 11, 2024 in the Korean Intellectual Property Office, the entire disclosure of which is incorporated herein by reference for all purposes.

### BACKGROUND

### 1. Field

The following description relates to a method and apparatus with dynamic environment state prediction.

### 2. Description of Related Art

Environmental understanding and interaction may be used in autonomous systems and robotics. Such a system must be able to recognize changes in various states and actions in an environment and make an adaptive and efficient decision based on this. In particular, a dynamic characteristic of an environment causes complexity in which a state changes over time or to which unpredictable elements are added.

State modeling and prediction techniques may be used to solve these problems. For example, a probabilistic model, a deep learning-based state prediction model, and a reinforcement learning-based decision-making model may be used. These models may analyze the correlation of pieces of data in an environment and predict a future state using trained information or determine an optimal action.

However, typical technology tends to consider all variables in an environment and complex correlations between pieces of data. This leads to a problem of rapidly increasing the amount of operations and increases the possibility that a model trains an unnecessary or inaccurate correlation. In addition, the typical technology may have a limitation in that the technology is unable to immediately adapt to a certain task or environmental change.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes extracting a first state variable from first observation data, extracting action data that acts according to an action policy, selecting a first selected causal variable variably based on the first state variable and the action data, extracting a predicted second state variable by predicting a state change based on the first selected causal variable and the action data, and training a dynamic causal environment model based on the predicted second state variable and second observation data.

The selecting of the first selected causal variable may include outputting a usage probability value for each of causal variables comprised in an entire causal variable set based on a correlation between the first state variable and the action data.

The selecting of the first selected causal variable may include selecting one or more causal variables according to a predetermined method based on the usage probability value.

The selecting of the one or more causal variables may include either one or both of selecting, from among the entire causal variable set, a fixed number of causal variables having greatest usage probability values, and selecting, from among the entire causal variable set, all causal variables having usage probability values that are greater than or equal to a predetermined reference value.

The extracting of the predicted second state variable may include generating a second selected causal variable by predicting a dynamic change of the first selected causal variable based on a relationship between the first selected causal variable and the action data.

The extracting of the predicted second state variable may include generating the predicted second state variable, which is an entire causal variable in a future, based on the second selected causal variable.

The training of the dynamic causal environment model may include updating the dynamic causal environment model based on a difference between the predicted second state variable and the second observation data.

The updating of the dynamic causal environment model may include updating an entire causal variable based on a second selected causal variable and the predicted second state variable.

The updating of the dynamic causal environment model may include training any one or any combination of any two or more of a causal variable selection model, a causal-based dynamic model, and an action decision model, which are comprised in the dynamic causal environment model.

The extracting of the first state variable may include generating the first state variable by converting the first observation data into an embedding vector.

The extracting of the first state variable may include converting the first observation data into a latent vector by encoding the first observation data.

The extracting of the action data may include determining the action data based on either one or both of a predefined action decision rule and an action decision model.

In one or more general aspects, an electronic device includes one or more processors configured to extract a first state variable from first observation data, extract action data that acts according to an action policy, select a first selected causal variable variably based on the first state variable and the action data, extract a predicted second state variable by predicting a state change based on the first selected causal variable and the action data, and train a dynamic causal environment model based on the predicted second state variable and second observation data.

For the selecting of the first selected causal variable, the one or more processors may be configured to output a usage probability value for each of causal variables comprised in an entire causal variable set based on a correlation between the first state variable and the action data.

For the selecting of the first selected causal variable, the one or more processors may be configured to select causal variables according to a predetermined method based on the usage probability value.

For the extracting of the predicted second state variable, the one or more processors may be configured to generate a second selected causal variable by predicting a dynamic change of the first selected causal variable based on a relationship between the first selected causal variable and the action data.

For the extracting of the predicted second state variable, the one or more processors may be configured to generate the predicted second state variable, which is an entire causal variable in a future, based on the second selected causal variable.

For the training of the dynamic causal environment model, the one or more processors may be configured to update the dynamic causal environment model based on a difference between the predicted second state variable and the second observation data.

For the updating of the dynamic causal environment model, the one or more processors may be configured to update an entire causal variable based on a second selected causal variable and the predicted second state variable.

For the updating of the dynamic causal environment model, the one or more processors may be configured to train any one or any combination of any two or more of a causal variable selection model, a causal-based dynamic model, and an action decision model, which are comprised in the dynamic causal environment model.

Other features and aspects will be apparent from the following detailed description, the drawings, and the claims.

### BRIEF DESCRIPTION OF THE DRAWINGS

FIG. 1 illustrates an example of a world model.

FIG. 2 illustrates an example of a causal model.

FIG. 3 illustrates an example of a state prediction method in a dynamic environment.

FIG. 4 illustrates an example of a dynamic causal environment model.

FIG. 5 illustrates an example of a causal variable selection model.

FIG. 6 illustrates an example of an operation of a dynamic causal environment model.

FIG. 7 illustrates an example of an electronic device.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which the present disclosure pertains and based on an understanding of the disclosure of the present application. Terms, such as those defined in commonly used dictionaries, should be construed to have meanings matching with contextual meanings in the relevant art and the disclosure of the present application, and are not to be construed to have an ideal or excessively formal meaning unless otherwise defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

The examples may be implemented as various types of products such as, for example, a personal computer, a laptop computer, a tablet computer, a smart phone, a television, a smart home appliance, an intelligent vehicle, a kiosk, and a wearable device. Hereinafter, the examples will be described in detail with reference to the accompanying drawings. When describing the examples with reference to the accompanying drawings, like reference numerals refer to like components and a repeated description related thereto will be omitted.

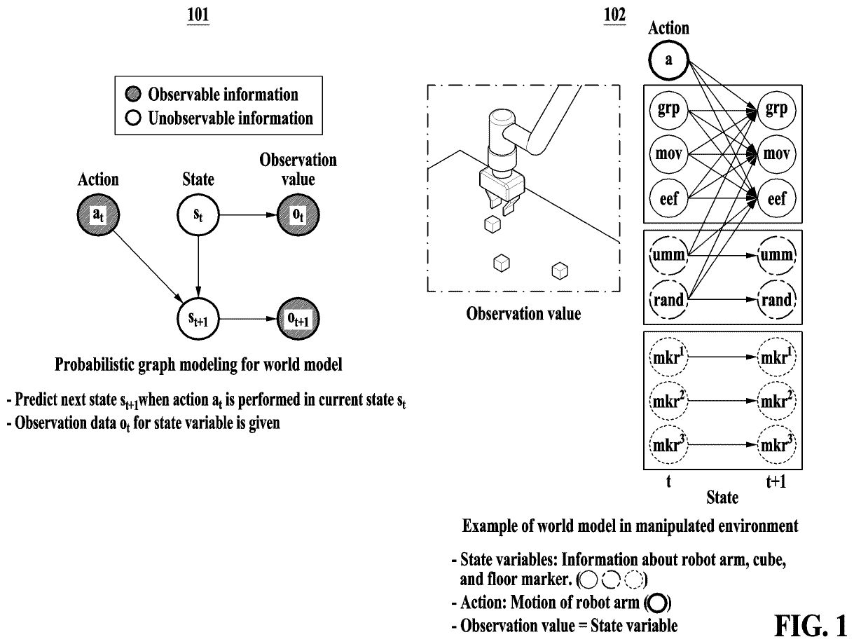

FIG. 1 illustrates an example of a world model.

FIG. 1 illustrates a diagram showing a probability-based world model 101 and an example of a world model in a manipulated environment 102.

The probability-based world model 101 may be a model that operates based on the relationship between a current state sₜ, an action aₜ, and an observation value oₜ. The current state sₜ is a state variable extracted from observation data and may represent a current environment. The current state sₜ may be changed by the action aₜ, and as a result, a future state sₜ₊₁ may be generated. The action aₜ may be determined by a predefined action policy and/or an action decision model and may predict the future state sₜ₊₁ through an interaction with the current state sₜ.

The observation value oₜ may represent information that is observable in the current state sₜ. The observation value oₜ may reflect a portion of the overall state, which may be generated based on sensor data and/or external input data. A future observation value oₜ₊₁ may be generated from the future state sₜ₊₁, which may represent observable data reflecting a changed state.

As shown in the diagram, the probability-based world model 101 may be configured as a graph structure in which a state, an action, and an observation value are expressed as nodes and the relationship therebetween is expressed as an edge. The action aₜ may connect the current state sₜ to the future state sₜ₊₁, and the observation value oₜ and the future observation value oₜ₊₁ may be connected to a current state and a future state, respectively. Through the probability-based world model 101, the relationship between a state and an action may be trained and a dynamic change in an environment may be predicted.

The example of the world model in the manipulated environment 102 illustrates an example of a process of operating a world model in a robot-manipulated environment. The example of the world model in the manipulated environment 102 may represent a robot arm (e.g., a manipulator) and various state variables, actions, and observation values in an environment.

The state variable may represent a current state of the environment, such as the position of the robot arm, the state of an object (e.g., a cube), and/or the position of a floor marker. The action may be a motion that the robot arm performs, which may include, for example, a motion in which the robot arm lifts the cube and/or moves the cube to a certain position. The observation value may be data obtained by the robot arm through a sensor and may be information that partially reflects the state variable.

In the example of the world model in the manipulated environment 102, the graph structure on the right may represent a method in which the current state sₜ and the action aₜ operate along the axis of time t. For example, the state variable sₜ at the time t may be changed by the action aₜ and the new state variable sₜ₊₁ and the observation value oₜ₊₁ may be generated at a time t+1 based on the state variable sₜ being changed by the action aₜ. As shown in the graph, it may be seen that the example of the world model in the manipulated environment 102 considers all causal variables to perform a certain task but the causal variables required for a corresponding task are limited. For example, when the robot arm performs the task of lifting the cube, only causal variables (such as the position of the cube and the position of the robot arm) may be used to perform the task, and another variable (such as the position of the floor marker) may not be necessary to perform the task because the variable does not affect the task.

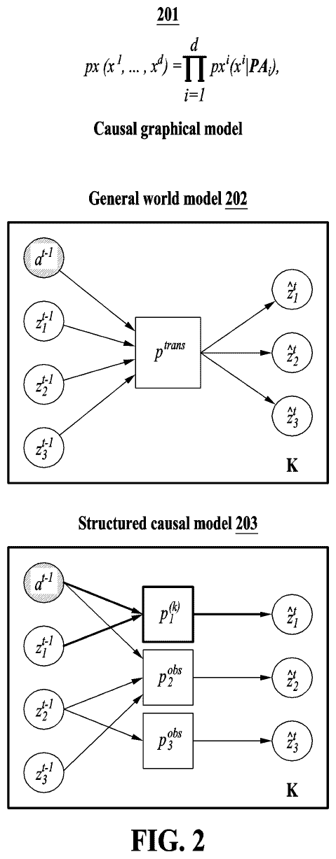

FIG. 2 illustrates an example of a causal model.

The description provided with reference to FIG. 1 may apply to FIG. 2, and any repeated description related thereto may be omitted.

A causal graphical model 201 may describe the probabilistic relationship between variables based on the causal relationship.

The causal graphical model 201 may decompose the entire probability distribution by determining a conditional probability between each variable xⁱ and a parent variable PAᵢ of a corresponding variable. This may express the causal relationship between variables as a graph and mathematically analyze an operation of a system based on the relationship.

For example, when x¹, x², . . . , x^{d} are not independent, the overall probability may be described by representing the relationship between each variable and a parent variable as a conditional probability. Through this, the relationship between variables in a complex system may be understood.

A general world model 202 may predict a future state x^{t} based on the relationship between a current state x^{t-1} and a current action a^{t-1}.

The general world model 202 may use action data and state data to train the dynamics of an environment and may model the relationship between states through a transfer function pₜᵣₐₙₛ. The general world model 202 may train the correlation between variables and use the correlation for prediction but may not clearly distinguish the causal relationship between the variables.

For example, when a robot arm performs the task of lifting a certain object, the relationships between the motion of the robot arm and the position of the object may be trained, but it may be difficult to verify whether the relationships are actually and causally connected using the general world model 202.

A structured causal model 203 may clearly and causally express the relationship between variables.

The structured causal model 203 may model values of variables as functional relationships, and through this, the influence of changes in each variable on other variables may be analyzed. Each transfer function p₁^{k}, p₂^{k}, and p₃^{k} in the diagram may clearly represent the causal relationship between state variables and actions and may ensure independence between each state variable.

Unlike the general world model 202, the structured causal model 203 may assume the independence between the state variables, and through this, the complex relationship between the variables may be clearly analyzed. For example, the influence of changes in the position of the robot arm on the movement of an object may be independently analyzed.

The examples described below relate to a causal world model that uses causal variables and predicts a future state, similar to the general world model 202 and the structured causal model 203 described above. For example, the method and apparatus of one or more embodiments may dynamically select causal variables and improve computational efficiency and accuracy.

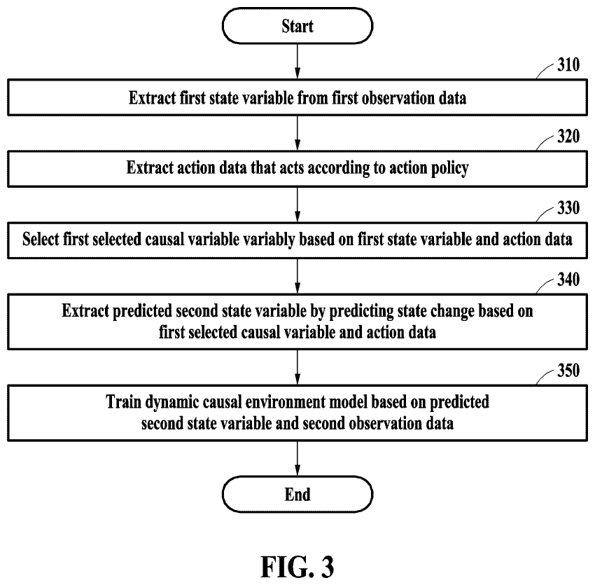

FIG. 3 illustrates an example of a state prediction method in a dynamic environment.

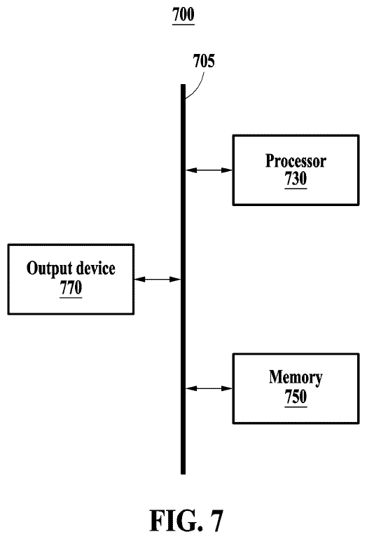

For ease of description, operations 310 to 350 are described as being performed by an electronic device 700 illustrated in FIG. 7. However, operations 310 to 350 may be performed by another suitable electronic device in a suitable system.

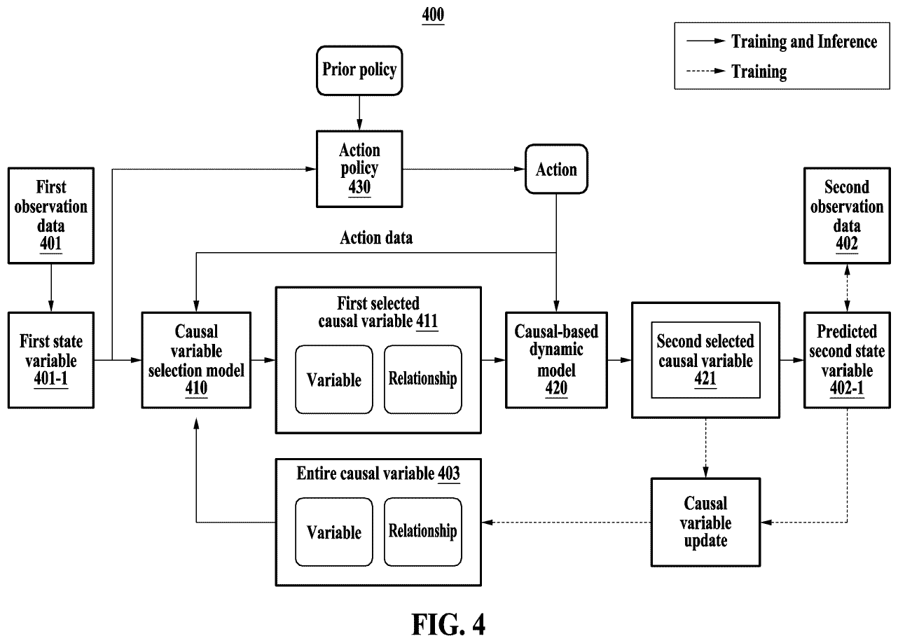

Furthermore, the operations of FIG. 3 may be performed in the shown order and manner. However, the order of one or more of the operations may be changed, one or more of the operations may be omitted, and/or two or more of the operations may be performed in parallel or simultaneously without departing from the spirit and scope of the shown examples. The operations 310 to 350 described below may be described in detail with reference to FIG. 4.

In operation 310, the electronic device 700 may extract a first state variable 401-1 from first observation data 401. The first observation data 401 may be collected from a sensor, a camera, and/or other input devices and may include information representing a current state of an environment.

The electronic device 700 may generate the first state variable 401-1 by converting the first observation data 401 into an embedding vector. The embedding vector may be a data structure that may compress and express a feature of observation data into a low-dimensional space, thereby enabling conversion into the first state variable 401-1.

The electronic device 700 may convert the first observation data 401 into a latent vector by encoding the first observation data 401. For example, when the observation data is an image and/or unstructured data, the electronic device 700 may convert the observation data into a latent vector by encoding the observation data. The latent vector may effectively express a state of the environment by extracting an important feature from the observation data.

For example, when the electronic device 700 is a system that controls a robot arm, the electronic device 700 may observe the position of an object in which a camera of the robot arm is on a table, convert the position of the object into an embedding vector, and express the position as the first state variable 401-1. This first state variable 401-1 may represent the current state of the environment, such as the position, size, and color of the object.

In operation 320, the electronic device 700 may extract action data that acts according to an action policy 430. The action data may define an action to be performed by the electronic device 700, and the action policy 430 may be determined by a predefined rule and/or a trained model.

The electronic device 700 may determine an action based on at least one of a predefined action decision rule and an action decision model. The electronic device 700 may select one of the possible actions based on the predefined action decision rule. The electronic device 700 may determine an action based on a certain condition in a predefined action space. In addition, the electronic device 700 may train the action decision model and generate an action that adaptively responds to a state variable and the observation data of the environment.

For example, in the process in which the electronic device 700 determines the motion of the robot arm, an operation of picking up and/or moving an object may be performed according to the predefined action rule. In addition, when the action decision model for the robot arm is trained, an optimal action may be generated according to the observed state variable and environment condition.

In operation 330, the electronic device 700 may select a first selected causal variable 411 variably based on the first state variable 401-1 and the action data.

The electronic device 700 may output a usage probability value for each of causal variables included in a set of an entire causal variable 403 based on the correlation between the first state variable 401-1 and the action data.

The electronic device 700 may select causal variables according to a predetermined method based on the usage probability value.

The entire causal variable 403 may be formed of a set of all possible states and action variables in a system, and the first selected causal variable 411 may be formed of variables selected as a result of correlation analysis on the entire causal variable 403. The electronic device 700 may be configured to evaluate the relationship between the first state variable 401-1 and the action data such that the first selected causal variable 411 may be extracted, which is most appropriate for a corresponding task.

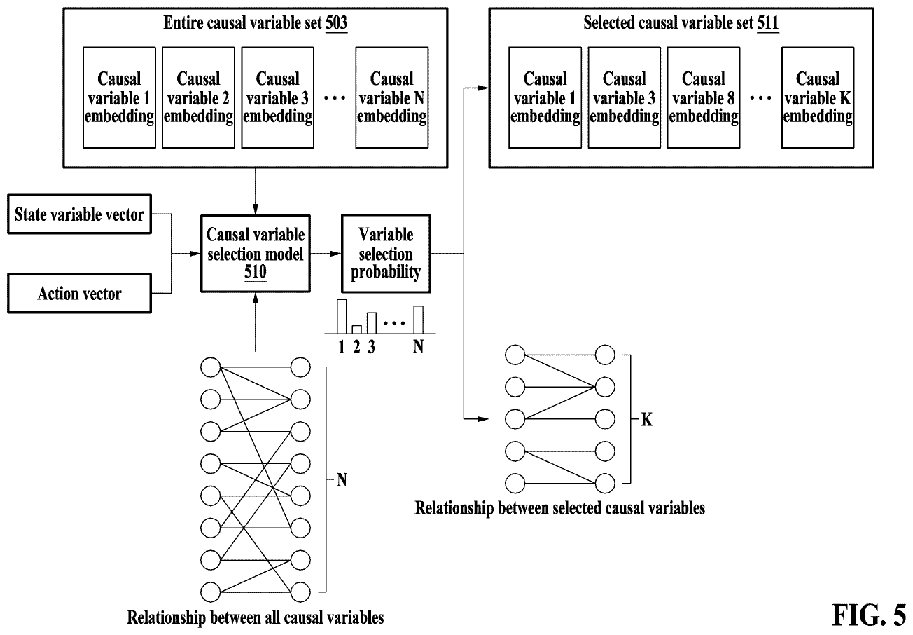

For example, when the robot arm performs the task of moving an object to a certain position, the set of the entire causal variable 403 may be formed of the position of the robot arm, the size of the object, the state of a table, etc. The electronic device 700 may select, as the first selected causal variable 411, only one or more variables that are important to the current task through correlation analysis. The position of the robot arm and the state of the object may be included as selected variables, and a variable with low relevance, such as the state of the table, may be excluded. An example of the process of selecting the causal variables is described in detail below with reference to FIG. 5.

In operation 340, the electronic device 700 may extract a predicted second state variable 402-1 by predicting a state change based on the first selected causal variable 411 and the action data. The electronic device 700 may determine the influence of an action on each variable based on the relationship between the first selected causal variable 411 and the action data. Through this, changes in a current state variable may be reflected in a predicted future state variable. For example, when the motion of the robot arm is moving the position of an object, the relationship between the motion of the robot arm and the position of the object may be analyzed such that the future position of the object may be accurately predicted.

The electronic device 700 may generate a second selected causal variable 421 by predicting a dynamic change of the first selected causal variable 411 based on the relationship between the first selected causal variable 411 and the action data. The electronic device 700 may analyze the influence of the action data on the first selected causal variable 411 by using a causal-based dynamic model 420. For example, a causal variable, such as the weight and/or size of an object, may vary depending on the operating method of the robot arm. The electronic device 700 may determine the relationship through the causal-based dynamic model 420, predict changes in the first selected causal variable 411 as a future state, and generate the second selected causal variable 421. When the robot arm performs the task of lifting an object at a certain position, the first selected causal variable 411 may include the position of the robot arm and the position of the object, the action data may include an operation of the robot arm grabbing and moving the object, and the second selected causal variable 421 may be the position of a new object and the position of a new robot arm.

The electronic device 700 may generate the predicted second state variable 402-1, which is the entire causal variable 403 in the future, based on the second selected causal variable 421. The second selected causal variable 421 may be an updated variable reflecting the interaction with the action data, and through this, the electronic device 700 may update only the first selected causal variable 411 to the second selected causal variable 421 in the entire causal variable 403 and may maintain the remaining causal variables. Accordingly, the predicted second state variable 402-1 may include all variables in the environment and may be used to predict a future state.

In operation 350, the electronic device 700 may train a dynamic causal environment model 400 based on the predicted second state variable 402-1 and second observation data 402. An example of the dynamic causal environment model 400 may be described in detail below with reference to FIG. 4. The predicted second state variable 402-1 may represent an expected value of the generated future state, and the second observation data 402 may represent actual data that is newly observed from the environment. The electronic device 700 may evaluate the performance of the dynamic causal environment model 400 by comparing the two pieces of data and may improve the prediction accuracy of the dynamic causal environment model 400 through training. The dynamic causal environment model 400 may gradually reflect a dynamic characteristic of the environment by repeating the training process.

The electronic device 700 may update the dynamic causal environment model 400 based on the difference between the predicted second state variable 402-1 and the second observation data 402. For example, the updating of the dynamic causal environment model 400 may be performed using a loss function (e.g., an L1 and/or a mean squared error (MSE) loss function) for the second observation data 402 and the predicted second state variable 402-1.

The electronic device 700 may adjust the dynamic causal environment model 400 such that a predicted value approaches an actual value by determining the difference between the predicted second state variable 402-1 and the second observation data 402 using a loss function. For example, a loss value may be determined using an L1 loss function (the absolute value difference) and/or an MSE loss function (the mean of squared differences). The loss function may be applied to minimize the error occurring in the update process of the dynamic causal environment model 400, and the dynamic causal environment model 400 may perform more accurate prediction through training.

The electronic device 700 may update the entire causal variable 403 based on the second selected causal variable 421 and the predicted second state variable 402-1. The entire causal variable 403 may include all state variables and pieces of action data (or action variables) considered in the system, and the second selected causal variable 421 may be a major variable related to the current task. The electronic device 700 may reestablish the relationship between the selected causal variables using the predicted second state variable 402-1 and the observation data and/or may add new causal variables and/or relationship to the entire causal variable 403 if necessary. The electronic device 700 may update the set of the entire causal variable 403 to better reflect the dynamic characteristic of the environment by updating the dynamic causal environment model 400.

The electronic device 700 may train at least one of a causal variable selection model 410, the causal-based dynamic model 420, and the action decision model, which are included in the dynamic causal environment model 400.

The electronic device 700 of one or more embodiments may improve the accuracy of selecting appropriate variables for each task by training the causal variable selection model 410. In addition, the causal-based dynamic model 420 of one or more embodiments may be trained to better reflect dynamic changes in the environment by analyzing the interaction between causal variables and the influence of the action data. Finally, when the action policy 430 is determined by the action decision model, the electronic device 700 may train the action decision model to select an optimal action based on the observation data and state variable. The training process of one or more embodiments may improve the performance of the dynamic causal environment model 400 as a whole and may enhance the adaptability to environmental changes.

For example, it may be assumed that the robot arm performs the task of moving an object to a certain position. The predicted second state variable 402-1 may represent an expected position of the object according to the motion of the robot arm. The second observation data 402 may be an actual task result and may represent the actual position of the object. The electronic device 700 of one or more embodiments may update the motion plan of the robot arm more accurately by determining the difference between the predicted second state variable 402-1 and the second observation data 402 using a loss function. In addition, the electronic device 700 of one or more embodiments may update the causal variables, such as the size, weight, and surface friction of the object, and may perform better prediction and planning in future tasks.

FIG. 4 illustrates an example of a dynamic causal environment model.

The description provided with reference to FIG. 3 may apply to FIG. 4, and any repeated description related thereto may be omitted.

One or more blocks shown in FIG. 4 or a combination thereof may be implemented by a special-purpose hardware-based computer that performs a predetermined function and/or a combination of computer instructions and special-purpose hardware.

Referring to FIG. 4, the dynamic causal environment model 400 may include the causal variable selection model 410 that extracts action data and the first state variable 401-1 and extracts the first selected causal variable 411 based on the action data and the first state variable 401-1, and the causal-based dynamic model 420 that extracts the second selected causal variable 421 from the first selected causal variable 411. In addition, the dynamic causal environment model 400 may update causal variables based on the difference between the predicted second state variable 402-1 and the second observation data 402 and may update models included in the dynamic causal environment model 400.

The first observation data 401 may be raw data collected from an environment and may be obtained through a sensor, a camera, and/or other input devices. The dynamic causal environment model 400 may extract the first state variable 401-1 based on the first observation data 401. The first state variable 401-1 may represent a current state of the environment, and through this, the dynamic relationship in the environment may be modeled. For example, when the first observation data 401 is image data, the electronic device 700 may convert the image data into a latent vector and express the latent vector as a state variable.

The dynamic causal environment model 400 may generate the action data based on the action policy 430, which is predefined, and/or a trained action decision model. For example, when a robot arm is to perform the task of picking up and moving a certain object, the action data may be data about the moving direction and speed of the robot arm.

The causal variable selection model 410 may receive the first state variable 401-1 and action data as inputs and may select the first selected causal variable 411 from the set of the entire causal variable 403. The first selected causal variable 411 may be formed of causal variables that are important to the current task, and the dynamic causal environment model 400 may select the first selected causal variable 411 through correlation analysis, a probability model, and/or a machine learning algorithm. For example, the robot arm and the position of the object may be selected, and unnecessary variables in the environment (e.g., table color) may be excluded.

The first selected causal variable 411 and the action data output from the causal variable selection model 410 may be transmitted to the causal-based dynamic model 420. The causal-based dynamic model 420 may predict dynamic changes in variables by analyzing the relationship between each variable. Through this, the second selected causal variable 421 may be generated, which may reflect changes in the current state and the influence of an action. For example, how the position of the object changes may be determined according to the motion of the robot arm.

The second selected causal variable 421 may be used to generate the predicted second state variable 402-1. The predicted second state variable 402-1 may represent an environment state in the future, which may be used to train the dynamic causal environment model 400 and/or plan the next task. For example, when an object moves to a certain position due to the movement of the robot arm, the predicted second state variable 402-1 may represent a state variable for the future position of the object.

The dynamic causal environment model 400 may be updated based on the difference between the second observation data 402, the predicted second state variable 402-1, and the actual observed state. The difference may be determined using a loss function (e.g., an MSE and/or an L1), and based on this, the components of the dynamic causal environment model 400 may be updated. An update target may be the entire causal variable 403, the causal variable selection model 410, the causal-based dynamic model 420, and the action decision model.

The dynamic causal environment model 400 may update the set of the entire causal variable 403 based on the updated result. The entire causal variable 403 may include all variables and relationships in a system and be configured to adapt to environmental changes. Accordingly, the update of the set of the entire causal variable 403 may be performed in a manner in which new variables and/or relationships are added and/or the importance of the existing variables are readjusted.

FIG. 5 illustrates an example of a causal variable selection model.

FIG. 5 illustrates a process of selecting necessary variables from an entire causal variable set 503. A causal variable selection model 510 may receive a state variable and action data as inputs and may output the relationship between a selected causal variable set 511 and a variable.

The entire causal variable set 503 may include a set of all causal variables considered in a system. The entire causal variable set 503 may be formed of N embedding vectors, and each embedding vector may represent a certain variable. For example, attributes, such as the position, size, and weight of an object in an environment, may each be expressed as a single embedding vector. The relationship between these variables may be represented in a graph structure, and the graph may be configured as a binary matrix and/or a matrix having a probability value. The graph structure may be used to describe the interdependence between the variables.

The causal variable selection model 510 may receive a state variable vector and an action vector as inputs and may select variables to be used among all causal variables. The state variable vector may represent a current state of the environment, and the action vector may represent an action to be performed in the corresponding state. The causal variable selection model 510 may be configured as a deep learning-based neural network and may output a probability vector for N-dimensional variable selection probability by processing input data. The probability vector may represent the possibility that each variable is selected, for example, a variable with a high probability value may be more likely selected.

The selected variables based on the probability vector may form the selected causal variable set 511.

For example, the variable selection may be performed in two ways. First, by selecting variables having the top K probability values, a fixed number of variables may be selected. Second, by selecting all variables of which probability values are greater than or equal to a predetermined reference (e.g., 0.5), a variable number of variables may be selected. The set of selected variables is part of the entire variable set and may include major data to be used in a subsequent process. However, the variable selection method is not limited to the described examples, may be dynamically adjusted, and may be selected by a method that may be adopted by those skilled in the art. In another non-limiting example, a variable having the greatest usage probability value may be selected as a first causal variable, and variables having a relationship with the selected first causal variable that is greater than or equal to another predetermined reference may be selected as other first causal variables.

The relationship between the selected causal variables may be generated by extracting partial matrices corresponding to the selected variables from the relationship matrix between all the existing variables. The relationship may describe the interaction between variables and may be used in the process of predicting and training a subsequent state change. A new relationship matrix may be formed by extracting only rows and columns of the selected causal variables from the relationship matrix, and an operation may be performed based on this.

The causal variable selection model 510 may be implemented in other ways. For example, the causal variable selection model 510 may be configured to output a certain embedding sequence rather than output the probability vector. In this case, variables having values that are most similar to the output embedding sequence may be selected.

For example, it may be assumed that a robot arm performs the task of moving one of several objects to a certain position. The entire causal variable set 503 may include the position, size, weight of the object, the position of the robot arm, the state of a table, etc. A model may select variables (e.g., the position and the size of the object) that are directly related to the motion of the robot arm by receiving the state variable vector and the action vector as inputs. The selected causal variables may be used in the process of predicting a subsequent state change and training the dynamic causal environment model 400.

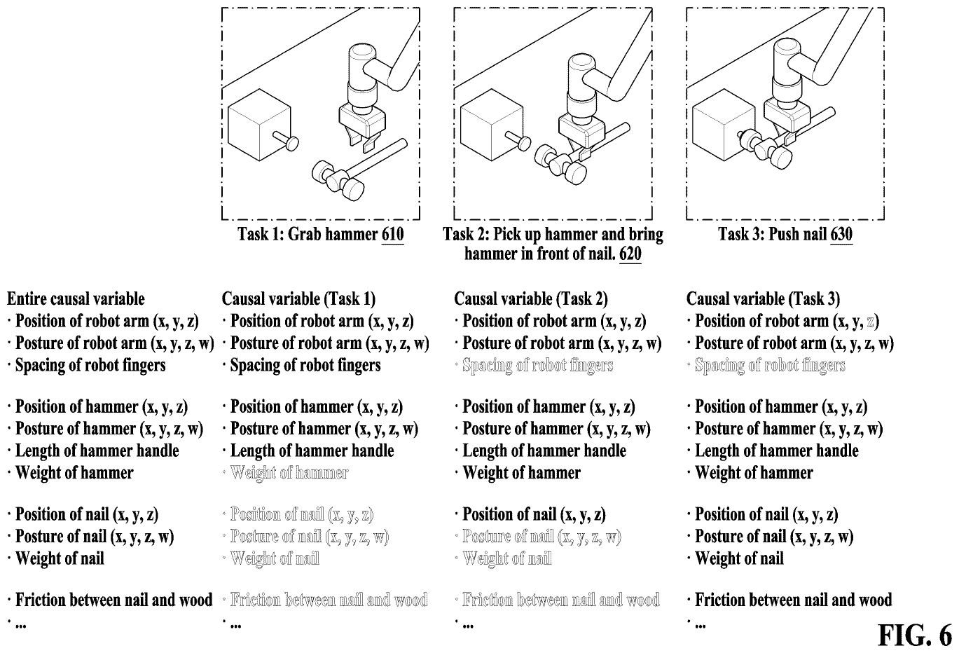

FIG. 6 illustrates an example of an operation of a dynamic causal environment model.

The description provided with reference to FIGS. 1 to 5 may apply to FIG. 6, and any repeated description related thereto may be omitted.

FIG. 6 illustrates an example of a process in which a robot arm drives a nail using a hammer. Here, it may be seen that a method in which the dynamic causal environment model 400 selects and uses causal variables required for each detailed task stage. This example illustrates a method in which the dynamic causal environment model 400 performs tasks efficiently by selecting only variables that are appropriate for the detailed task.

For example, it may be assumed that a robot performs three detailed tasks. The first task, task 1 610, may be the task in which the robot arm grabs a hammer. The task 1 610 may require causal variables such as a position (x, y, z) of the robot arm and a position and posture (x, y, z, w) of the hammer. The spacing between the fingers of the robot may also play an important role in the success of the task. However, a variable related to the nail (e.g., the position of the nail and/or the friction between the nail and the wood) may not be used at this stage. This approach of one or more embodiments may reduce computational costs and errors that may occur due to unnecessary variables in the task.

The second task, task 2 620, may be the task in which the robot arm picks up the hammer and brings the hammer in front of the nail. In the task 2 620, position information of the hammer and the robot arm, used in the task 1 610, may be maintained. Additionally, the weight of the hammer and the length of the handle may be considered. These variables may be necessary to lift the hammer stably. However, a variable related to the position of the nail may still not be important, and the dynamic causal environment model 400 may exclude this variable.

The third task, task 3 630, may be the task of pushing the nail into the wood using the hammer. In the task 3 630, the position of the nail, the posture of the hammer, and the weight of the hammer may act as important variables. Additionally, a physical variable, such as friction between the nail and the wood, may also be considered. The spacing of the fingers of the robot used in the previous task may no longer be and important variable, and the dynamic causal environment model 400 may exclude this variable. The dynamic causal environment model 400 may select and use only variables required for each task.

When all variables (e.g., the position of the nail and the position of the hammer) are considered in the task 1 610, a general world model may likely train an incorrect correlation. The dynamic causal environment model 400 of one or more embodiments may prevent such errors and improve the robustness against the causal variable selection according to environmental changes by selecting only the variables that are necessary for each task. In addition, the method and apparatus of one or more embodiments may improve computational efficiency by selecting only appropriate causal variables for each task stage, and may perform fast and accurate prediction and training even in a complex environment.

FIG. 7 illustrates an example of an electronic device.

The description provided with reference to FIGS. 1 to 6 may apply to FIG. 7, and any repeated description related thereto may be omitted.

Referring to FIG. 7, the electronic device 700 may include a processor 730 (e.g., one or more processors), a memory 750 (e.g., one or more memories), and an output device 770 (e.g., a display). The processor 730, the memory 750, and the output device 770 may be connected to each other via a communication bus 705. The electronic device 700 may include the processor 730 for performing at least one method described above or an algorithm corresponding to the at least one method, for operating the electronic device 700.

The output device 770 may display a user interface related to a state prediction method in a dynamic environment provided by the processor 730. The output device 770 may be the same device as the display included in the electronic device 700. Additionally, the output device 770 may be embedded in the electronic device 700 to display the user interface or may be an external display device.

The memory 750 may store pieces of data related to the state prediction method in the dynamic environment performed by the processor 730. In addition, the memory 750 may store various pieces of information generated in the processing process of the processor 730 described above. In addition, the memory 750 may store various types of data and programs. The memory 750 may include a volatile memory or a non-volatile memory. The memory 750 may store a variety of data by including a large mass storage medium, such as a hard disk.

In addition, the processor 730 may perform at least one method described with reference to FIGS. 1 to 7 and/or an algorithm corresponding to the at least one method. In the above-described process, the processor 730 may be a hardware-implemented data processing device having a circuit that is physically structured to execute desired operations. For example, the desired operations may include code and/or instructions included in a program. The processor 730 may be implemented as, for example, a central processing unit (CPU), a graphics processing unit (GPU), and/or a neural processing unit (NPU). The electronic device 700, which is implemented by hardware, may include, for example, a microprocessor, a CPU, a processor core, a multi-core processor, a multiprocessor, an application-specific integrated circuit (ASIC), and a field-programmable gate array (FPGA).

The processor 730 may execute a program and control the electronic device 700. Code of the program to be executed by the processor 730 may be stored in the memory 750. For example, the memory 750 may be or include a non-transitory computer-readable storage medium storing code that, when executed by the processor 730, configures the processor 730 to perform any one, any combination, or all of the operations and/or methods disclosed herein with reference to FIGS. 1-6.

The electronic devices, processors, memories, output devices, communication buses, electronic device 700, processor 730, memory 750, output device 770, and communication bus 705 described herein, including descriptions with respect to respect to FIGS. 1-7, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-7 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
extracting a first state variable from first observation data;
extracting action data that acts according to an action policy;
selecting a first selected causal variable variably based on the first state variable and the action data;
extracting a predicted second state variable by predicting a state change based on the first selected causal variable and the action data; and
training a dynamic causal environment model based on the predicted second state variable and second observation data.

2. The method of claim 1, wherein the selecting of the first selected causal variable comprises outputting a usage probability value for each of causal variables comprised in an entire causal variable set based on a correlation between the first state variable and the action data.

3. The method of claim 2, wherein the selecting of the first selected causal variable comprises selecting one or more causal variables according to a predetermined method based on the usage probability value.

4. The method of claim 3, wherein the selecting of the one or more causal variables comprises either one or both of:
selecting, from among the entire causal variable set, a fixed number of causal variables having greatest usage probability values; and
selecting, from among the entire causal variable set, all causal variables having usage probability values that are greater than or equal to a predetermined reference value.

5. The method of claim 1, wherein the extracting of the predicted second state variable comprises generating a second selected causal variable by predicting a dynamic change of the first selected causal variable based on a relationship between the first selected causal variable and the action data.

6. The method of claim 5, wherein the extracting of the predicted second state variable comprises generating the predicted second state variable, which is an entire causal variable in a future, based on the second selected causal variable.

7. The method of claim 1, wherein the training of the dynamic causal environment model comprises updating the dynamic causal environment model based on a difference between the predicted second state variable and the second observation data.

8. The method of claim 7, wherein the updating of the dynamic causal environment model comprises updating an entire causal variable based on a second selected causal variable and the predicted second state variable.

9. The method of claim 7, wherein the updating of the dynamic causal environment model comprises training any one or any combination of any two or more of a causal variable selection model, a causal-based dynamic model, and an action decision model, which are comprised in the dynamic causal environment model.

10. The method of claim 1, wherein the extracting of the first state variable comprises generating the first state variable by converting the first observation data into an embedding vector.

11. The method of claim 1, wherein the extracting of the first state variable comprises converting the first observation data into a latent vector by encoding the first observation data.

12. The method of claim 1, wherein the extracting of the action data comprises determining the action data based on either one or both of a predefined action decision rule and an action decision model.

13. An electronic device comprising:
one or more processors configured to:
extract a first state variable from first observation data;
extract action data that acts according to an action policy;
select a first selected causal variable variably based on the first state variable and the action data;
extract a predicted second state variable by predicting a state change based on the first selected causal variable and the action data; and
train a dynamic causal environment model based on the predicted second state variable and second observation data.

14. The electronic device of claim 13, wherein, for the selecting of the first selected causal variable, the one or more processors are configured to output a usage probability value for each of causal variables comprised in an entire causal variable set based on a correlation between the first state variable and the action data.

15. The electronic device of claim 14, wherein, for the selecting of the first selected causal variable, the one or more processors are configured to select causal variables according to a predetermined method based on the usage probability value.

16. The electronic device of claim 13, wherein, for the extracting of the predicted second state variable, the one or more processors are configured to generate a second selected causal variable by predicting a dynamic change of the first selected causal variable based on a relationship between the first selected causal variable and the action data.

17. The electronic device of claim 16, wherein, for the extracting of the predicted second state variable, the one or more processors are configured to generate the predicted second state variable, which is an entire causal variable in a future, based on the second selected causal variable.

18. The electronic device of claim 13, wherein, for the training of the dynamic causal environment model, the one or more processors are configured to update the dynamic causal environment model based on a difference between the predicted second state variable and the second observation data.

19. The electronic device of claim 18, wherein, for the updating of the dynamic causal environment model, the one or more processors are configured to update an entire causal variable based on a second selected causal variable and the predicted second state variable.

20. The electronic device of claim 18, wherein, for the updating of the dynamic causal environment model, the one or more processors are configured to train any one or any combination of any two or more of a causal variable selection model, a causal-based dynamic model, and an action decision model, which are comprised in the dynamic causal environment model.
